(19) United States
(12) Patent Application Publication
(10) Pub. No.: US 2024/0378798 A1
(43) Pub. Date: Nov. 14, 2024

(54) AUGMENTED REALITY SIGN DESIGN AND PLANNING METHODS AND SYSTEMS

(71) Applicant: Timothy Rose, Brooksville, FL (US)

(72) Inventor: Timothy Rose, Brooksville, FL (US)

(21) Appl. No.: 18/195,368

(22) Filed: May 9, 2023

Related U.S. Application Data
(60) Provisional application No. 63/319,270, filed on Mar. 11, 2022.

(51) Int. Cl. G06T 15/20; G06T 19/00; G06T 19/20

(52) U.S. Cl. CPC G06T 15/205; G06T 19/006; G06T 19/20

(57) ABSTRACT

Methods, systems and computer readable media for augmented reality sign design and planning are described.

### RELATED APPLICATIONS

This application claims the benefit of U.S. Application No. 63/319,270, entitled “Augmented Reality Sign Design and Planning Methods and Systems,” and filed on Mar. 11, 2022, which is incorporated herein by reference in its entirety.

### TECHNICAL FIELD

Embodiments relate generally to augmented reality systems, and more particularly, to methods, systems and computer readable media for augmented reality sign design and planning.

### BACKGROUND

Conventional processes for designing, planning, and acquiring a sign can take weeks or even months. From the initial contact with the client, a conventional process was to determine the customer's needs, discover placement, create a drawing, submit request for manufacturer pricing, research zoning and ordinance, acquire payments, apply for permits, and finally break ground.

Some implementations were conceived in light of the above-mentioned needs, problems and/or limitations, among other things. The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

FIG. 1 is a block diagram of an example system and a network environment which may be used for one or more implementations described herein.

FIG. 2 is a flowchart of an example method for augmented reality sign design and planning in accordance with some implementations.

FIG. 3 is a flowchart of an example method for augmented reality sign design and planning in accordance with some implementations.

FIG. 4 is an example graphical user interface showing an example augmented reality sign design and planning application showing an existing conventional sign image in accordance with some implementations.

FIG. 5 is an example graphical user interface showing an example augmented reality sign design and planning application showing an augmented reality sign image in accordance with some implementations.

FIG. 6 is an example graphical user interface showing an example augmented reality sign design and planning application showing an existing sign site in accordance with some implementations.

FIG. 7 is an example graphical user interface showing an example augmented reality sign design and planning application showing an augmented reality sign image in accordance with some implementations.

FIG. 8 is an example graphical user interface showing an example augmented reality sign design and planning application showing an augmented reality sign image in accordance with some implementations.

FIG. 9 is an example graphical user interface showing an example augmented reality sign design and planning application in accordance with some implementations.

FIG. 10 is a diagram of an example computing device configured for augmented reality sign design and planning in accordance with at least one implementation.

### DETAILED DESCRIPTION

Some implementations can include use of augmented reality (AR) or extended reality (XR) technology to simplify sign design and planning processes. Conventional processes for designing, planning, and acquiring a sign can take weeks or even months. From the initial contact with the client, a conventional process was to determine the customer's needs, discover placement, create a drawing, submit request for manufacturer pricing, research zoning and ordinance, acquire payments, apply for permits, and finally break ground. Some implementations can permit some or all of these steps to be done by the end user (or customer) or on the initial visit by a sign company representative via the software or mobile application.

Some implementations are designed to be a virtual salesperson for sign companies across the country. The mobile app can permit a salesperson to take orders and dropship signs to end users for those that choose to install and handle permitting themselves, or to sell sign customer leads to sign companies. Some implementations can permit a user to acquire new leads for sign jobs.

Some implementations help reduce miscommunications for aspects such as sign models and placement. Some implementations permit end-users to see in real time (or near real time) what an LED (or other digital sign) display is and how it works, visualize different resolutions and how they will look, and how many lines of text will fit in how clear the sign will be. Conventional solutions such as photo-shopped drawings from sign manufacturers does not give the same visualization as the AR implementation can. Some implementations include AR visualization of static (or non-electronic) signs and billboards.

Some implementations can include a screen guide tutorial for the first time opening the app. After completing the training tutorial, a user will not have the circles (or other markings or indications) showing the user where to click. The user can open the app and is free to just choose different signs and place them in different locations.

Images saved to a user's camera roll will be watermarked. Once the user submits his/her email address and requests a quote/pricing, the user will receive unwatermarked AR simulated images via email. This is the lead generation portion of the app.

In some implementations, leads used will be integrated into third-party CRM software or used within the app for marketing purposes via internal CRM software.

In some implementations, income will be generated through multiple streams within the app, such as 1) selling signs directly and drop shipping to the customer; 2) using links to connect the user to apply for financing, and receiving referral/finder's fee from finance companies; 3) selling the leads to sign companies in areas not serviced (nationwide); 4) allowing premium placement or promoted signs from the sign selection within the app (recommended manufacturers/models); and 5) charging a monthly user subscription fee to these full version users for sign companies, among others.

Some implementations of the app can be written in a language that will be used on both Apple and Android devices or other devices.

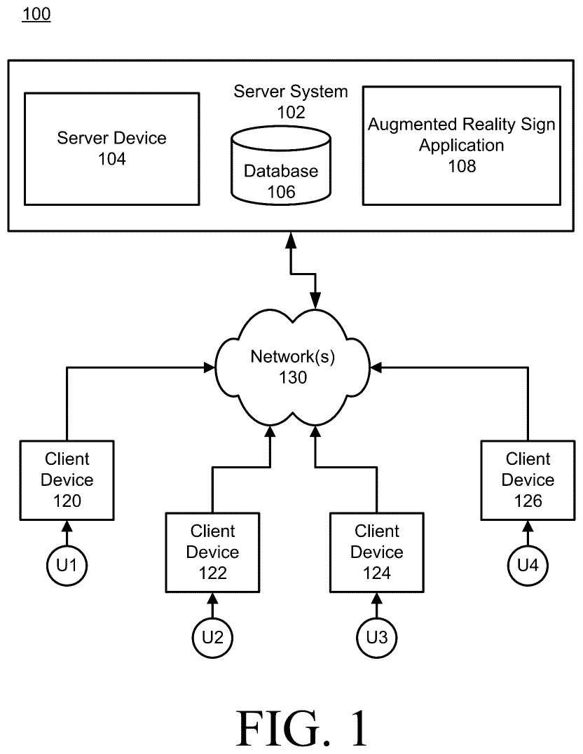

FIG. 1 illustrates a block diagram of an example network environment 100, which may be used in some implementations described herein. In some implementations, network environment 100 includes one or more server systems, e.g., server system 102 in the example of FIG. 1A. Server system 102 can communicate with a network 130, for example. Server system 102 can include a server device 104, a database 106 or other data store or data storage device, and an augmented reality sign design and planning application 108. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide augmented reality (or extended reality) sign design and planning functions.

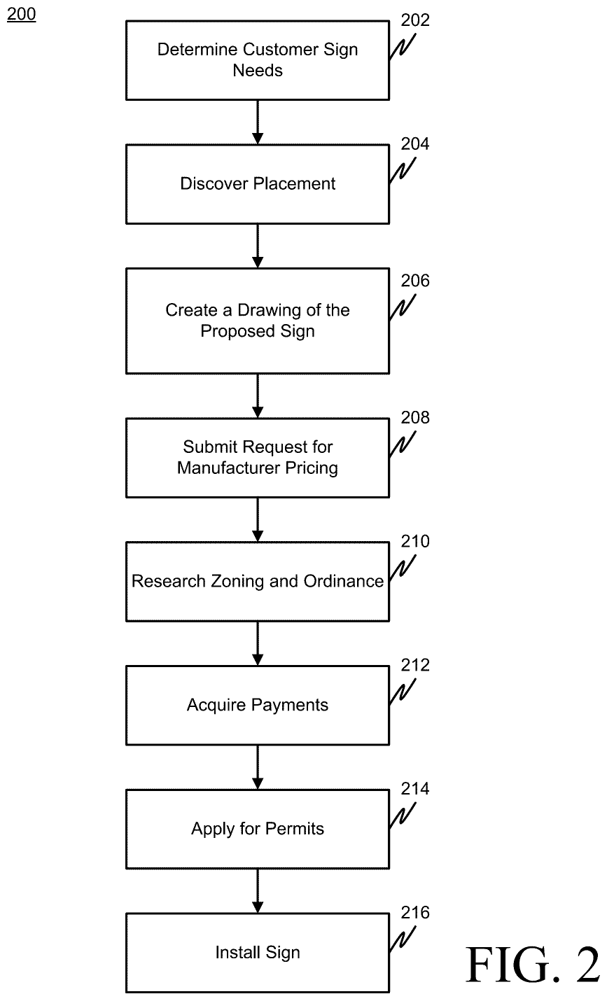

FIG. 2 is a flowchart of an example method to for augmented reality sign design and planning in accordance with some implementations. Processing begins at 202, where customer sign needs are determined. For example, a user can select from among a variety of sign sizes, resolutions, etc., and the augmented reality sign design and planning application can receive the selection of one or more sign designs. Processing continues to 204.

At 204, placement is discovered. For example, a user can scan an area with their mobile device and determine new sign placement (e.g., as an addition to an existing sign, as a new sign to replace an existing sign, or at a site for a completely new sign. Processing continues to 206.

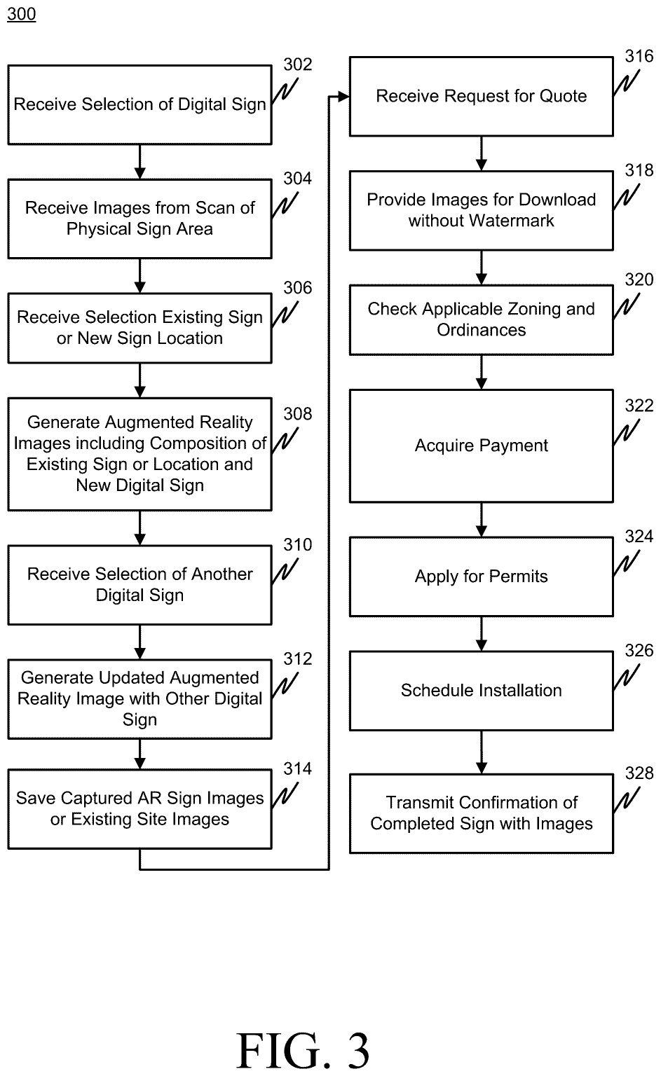

At 206, a drawing or image of a new sign is created. This is discussed in greater detail below in connection with FIG. 3. Processing continues to 208.

At 208, a request can be submitted for pricing. Processing continues to 210.

At 210, zoning and ordinances are researched based on site location and signs selected. Processing continues to 212.

At 212, payments are acquired from the user (e.g., via electronic payment processors). Processing continues to 214.

At 214, permits are applied for. For example, the system may electronically submit a permit application based on user information and ordered sign information. Processing continues to 216.

At 216, the sign is installed. This is a physical process but can be optionally documented with the app and a notification sent to the user that the sign installation has been completed along with an optional image of the installed sign.

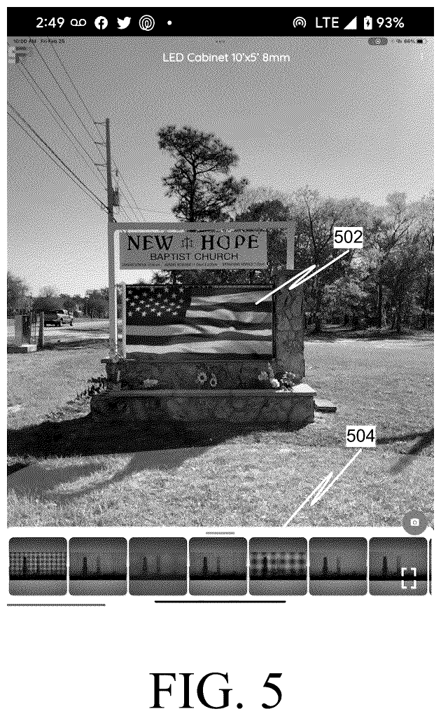

FIG. 3 is a flowchart of an example method to for augmented reality sign design and planning in accordance with some implementations. Processing begins at 302, where a selection of one or more digital or electronic signs is received at the augmented reality sign design and planning system. For example, the one or more sign scan be selected via the example user interface elements shown in FIG. 5, at 504. Processing continues to 304.

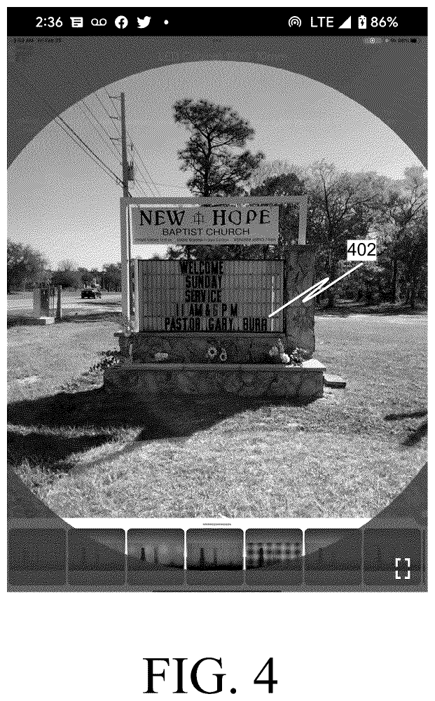

At 304, an image (e.g., a still image or a video image) is received from a scan of a physical sign area, see, e.g., FIG. 4. Processing continues to 306.

At 306, a selection of an existing sign or sign site is received. For example, selection of an existing sign 402 as shown in FIG. 4. Processing continues to 308.

At 308, an augmented reality image is generated that includes a composition of an existing sign or location and a new digital or electronic sign. For example, FIG. 5 shows an augmented reality image with an electronic sign within an existing sign frame. Processing continues to 310.

At 310, optionally a selection of another digital or electronic sign is received. Processing continues to 312.

At 312, an updated augmented reality image (e.g., still images or video) is generated with the other digital sign included. Processing continues to 314.

At 314, captured images (still or video) of augmented reality signs or existing signs or sign sites are saved. Processing continues to 316.

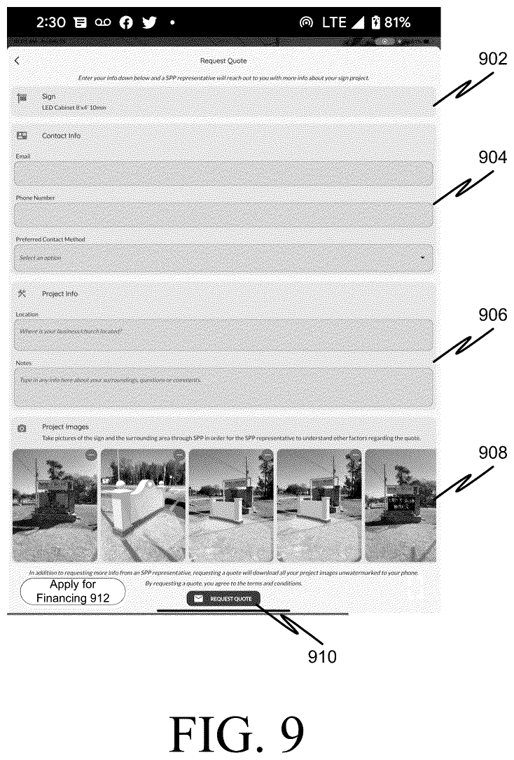

At 316, a request for a price quote on one or more electronic signs is received. For example, a user may enter information and select receive a quote as shown in FIG. 9. Processing continues to 318.

At 318, after a request for a quote is received, saved images are provided without a watermark (e.g., emailed or sent via messaging). Processing continues to 320.

At 320, applicable zoning and ordinances are optionally checked electronically. For example, the augmented reality sign design and planning application can access a database of zoning and ordinances (e.g., an integrated database or a third-party ordinance/zoning database) to determine if a given sign choice is permitted at the desire location entered by a user. Processing continues to 322.

At 322, payment for the electronic or digital sign is acquired electronically (e.g., via integrated payment processing or via a third-party payment acquisition system such as Stripe or PayPal). Processing continues to 324.

At 324, applicable permits are electronically applied for. Processing continues to 326.

At 326, once the permits are granted electronically, the sign installation is scheduled. Processing continues to 328.

At 328, an electronic notification of sign installation completion is optionally sent to the user and/or salesperson along with an optional image of the installed sign.

FIG. 4 is an example graphical user interface showing an example augmented reality sign design and planning application showing an existing conventional sign image 402 in accordance with some implementations.

FIG. 5 is an example graphical user interface showing an example augmented reality sign design and planning application showing an augmented reality sign image 502 and sign type selection interface 504 in accordance with some implementations.

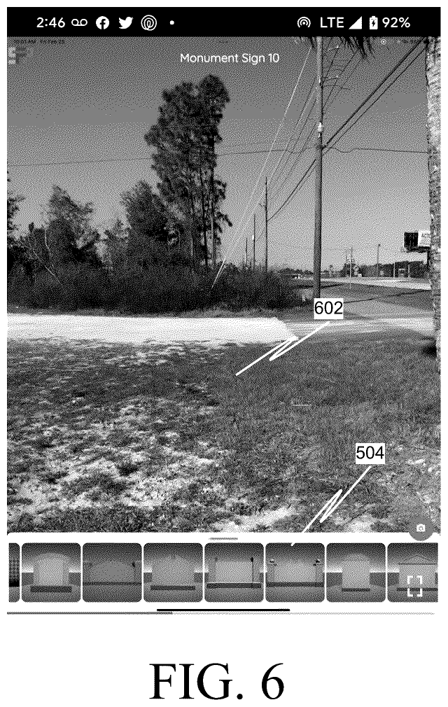

FIG. 6 is an example graphical user interface showing an example augmented reality sign design and planning application showing an existing sign site 602 in accordance with some implementations.

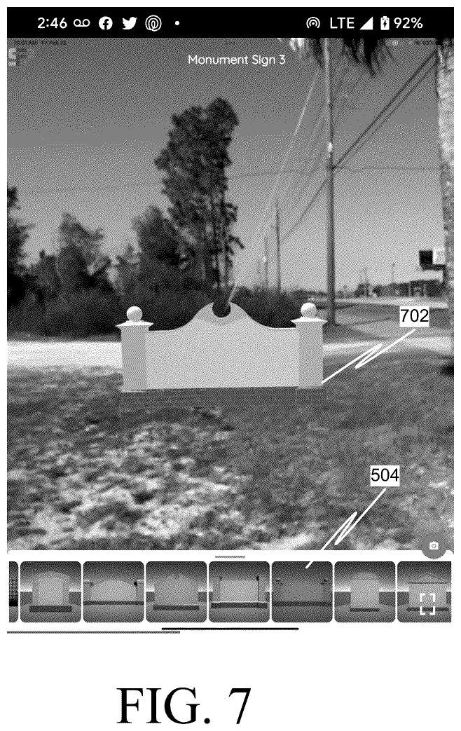

FIG. 7 is an example graphical user interface showing an example augmented reality sign design and planning application showing an augmented reality sign image 702 in accordance with some implementations.

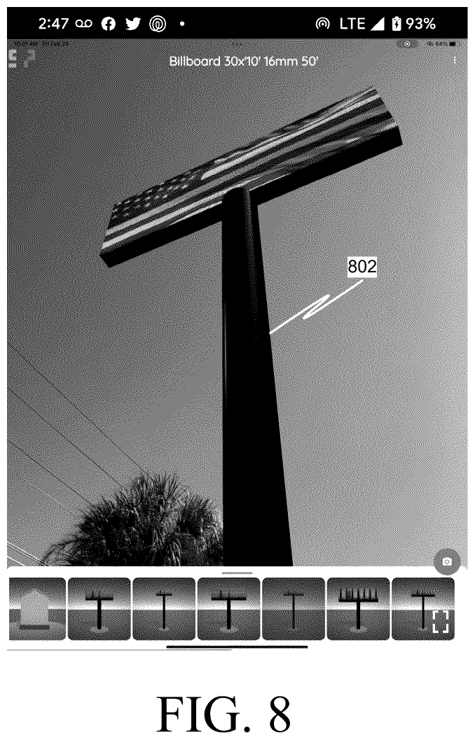

FIG. 8 is an example graphical user interface showing an example augmented reality sign design and planning application showing an augmented reality sign image 802 in accordance with some implementations.

FIG. 9 is an example graphical user interface showing an example augmented reality sign design and planning application in accordance with some implementations. FIG. 9 shows a sign type selection 902, user/customer contact information 904, project information 906, project images 908, submit a request for contact/quote element 910, and a link or element to apply for financing 912.

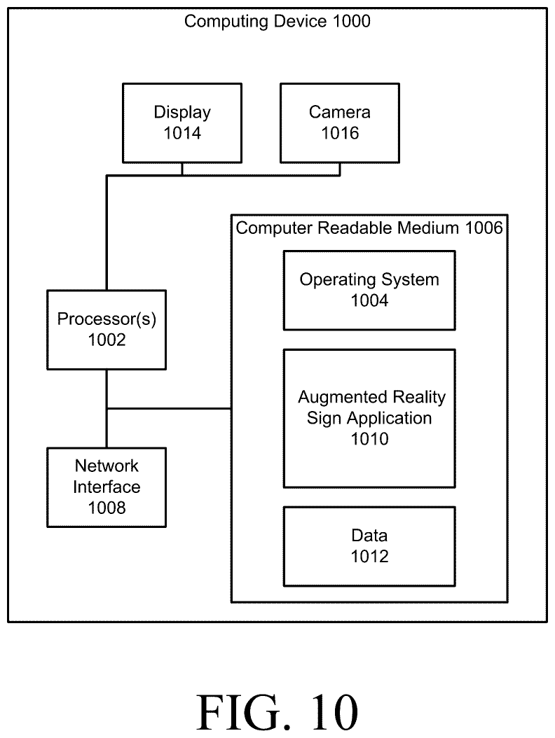

FIG. 10 is a diagram of an example computing device 1000 in accordance with at least one implementation. The computing device 1000 includes one or more processors 1002, nontransitory computer readable medium 1006, network interface 1008, optional display 1014, and optional camera 1016. The computer readable medium 1006 can include an operating system 1004, an application 1010 for augmented reality sign design and planning application and a data section 1012 (e.g., for storing sign selection, customer data, AR sign images, sign site images, zoning and ordinance information, etc.).

In operation, the processor 1002 may execute the application 1010 stored in the computer readable medium 1006. The application 1010 can include software instructions that, when executed by the processor, cause the processor to perform augmented reality sign design and planning operations in accordance with the present disclosure (e.g., displaying and controlling augmented reality sign design and planning user interfaces shown in FIGS. 4-9 and performing associated functions described above and in FIGS. 2 and 3).

The application program 1010 can operate in conjunction with the data section 1012 and the operating system 1004.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C #.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general-purpose computer, a special purpose computer, a microprocessor, a network server or switch, or the like.

It is, therefore, apparent that there is provided, in accordance with the various embodiments disclosed herein, methods, systems and computer readable media to perform augmented reality sign design and planning operations.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A computer implemented method comprising:
receiving a selection of a digital sign;
receiving one or more images or scans of a physical sign location area;
generating an augmented reality image including a composition of an existing sign or location and the digital sign;
receiving selection of another digital sign; and
updating the augmented reality image with the other digital sign.
